(19) United States
(12) Patent Application Publication
(10) Pub. No.: US 2024/0312007 A1
(43) Pub. Date: Sep. 19, 2024

(54) PET IMAGE ANALYSIS AND RECONSTRUCTION BY MACHINE LEARNING

(71) Applicant: AARHUS UNIVERSITET, Aarhus C (DK)

(72) Inventor: Thomas Mejer Hansen, Knebel (DK)

(21) Appl. No.: 18/546,953

(22) PCT Filed: Feb. 28, 2022
(86) PCT No.: PCT/EP2022/054999

§ 371 Date: Aug. 17, 2023

(30) Foreign Application Priority Data
Mar. 1, 2021 (EP) 21159931.1

(51) Int. Cl. G06T 7/00; G06T 11/00

(52) U.S. Cl. CPC G06T 7/0012; G06T 11/006; G06T 2207/10104; G06T 2207/20021; G06T 2207/20081; G06T 2207/20084; G06T 2207/30096; G06T 2210/41

(57) ABSTRACT

A device and a method for image reconstruction for medical imaging is provided. The method comprises obtaining a PET image and dividing the PET image into localized subset images, each subset image being analyzed by a trained machine learning system obtaining an output for each subset image processed by the machine learning system and determine a representation output based on the outputs.

### FIELD OF THE INVENTION

The present invention relates to image analysis and reconstruction for medical imaging by using neural networks and machine learning, and in particular to a device and a method of position emission tomography (PET) image analysis and reconstruction.

### BACKGROUND OF THE INVENTION

The use of image reconstruction, enhancement and analysis are widely used on images related to medical scanners. For example, in PET scanning, a radioactive tracer is injected into a patient and it is constructed such that cancer cells will accumulate the tracer material. A PET scanner is then used to record the radioactive decay, and provide a reconstructed PET image representing the in-situ distribution of tracer intensity. A high tracer intensity can be indicative of cancer lesions.

Clinical oncology is heavily exploiting positron emission tomography (PET) searching for, monitoring and imaging tumours and metastases. In diagnostics, monitoring and research medical imaging techniques are increasingly used. PET scanning is also used as an important tool for clinical diagnosis of brain diseases and in general for mapping heart function and brain of humans.

However, the PET image is contaminated by blurring and noise, related to how the PET data has been recorded. To remove blurring and noise, and to allow analysis of features of the in situ tracer intensity, a Bayesian approach to image reconstruction can be posed as a probabilistic inverse problem.

See the reference: Tarantola, A., & Valette, B. (1982). Inverse problems=quest for information. Journal of geophysics, 50(1), 159-170.

In the Bayesian approach prior information, quantified through a prior probability distribution ρ(m), of the expected tracer intensity is combined with a description of how well the forward response of the model fits observed data, as quantified through the likelihood function, L(m). The general solution to the probabilistic/Bayesian formulation of an inverse problem is a probability distribution, the posterior probability distribution σ(m).

$$σ ( m ) = ρ ( m ) * L ( m ) \qquad ( 1 )$$

Except for linear Gaussian inverse problems, an analytical description of σ(m) is not feasible. Instead, Markov chain Monte Carlo based sampling methods, such as the Metropolis-Hastings algorithm, exist that allow sampling of σ(m). While guaranteed to in principle sample the correct posterior probability distribution σ(m), such sampling methods become both computationally expensive, to the point where they cannot be practically applied, and the results difficult to interpret.

Continuous efforts are made to increase the image quality of medical images and in particular, PET image processing methods, however improving the image quality of PET images is still desired.

Hence, an improved image reconstruction would be advantageous, and in particular, a more efficient and/or reliable method for image reconstruction would be advantageous.

### OBJECT OF THE INVENTION

It is an object of the present invention to provide an improvement in the quality and the speed of making Bayesian image analysis and reconstruction of PET images.

In particular, it may be seen as an object of the present invention to provide a method that solves parts of the above-mentioned problems of the prior art with similar image quality and doing it faster than known Bayesian methods of medical image analysis and reconstruction to improve the detectability of tumours.

### SUMMARY OF THE INVENTION

Thus, the above-described object and several other objects are intended to be obtained in a first aspect of the invention by providing a faster method for image reconstruction for medical imaging of a subject. The subject can be a human or an animal.

The invention is particularly, but not exclusively, advantageous for obtaining improved detection and identification of small tumours.

The purpose of the invention is to analyse and possible reconstruct an image scanned in a PET scanner. The PET scan, the reconstructed PET image, from here-on referred to as a PET image, d_{obs}, can be 2-dimensional or a 3-dimensional image covering parts of a human body. In the invention, the PET image is divided into a plurality of small, localized images, hereon called subset-images, dₛₛₒ. A subset-image dₛₛₒ is a localized image covering a small part of the full PET image, d_{obs}.

A machine learning system, preferable a neural network, is in the invention used to analyse the PET image. This is done by analysing the plurality of subset-images dₛₛₒ one at a time, using the subset-image dₛₛₒ as input for the machine learning system.

To train the machine learning system training sets are made based on collecting expert data, representing ρ(m), and use this data to create training sets for training the machine learning system to be able to improve the quality of PET scans of humans or animals and analyse the PET scan for possible cancer, by estimating properties of the posterior probability distribution σ(m).

Here, we present a method, relying on machine learning. A training set for a machine learning algorithm is generated based on use of arbitrarily complex prior information, here-on referred to as the prior ρ(m). The method is based on selecting models m from the prior; the models selected from the prior are used to create data-images d, which are used as input for the machine learning system to represent the subset-images dₛₛₒ.

The models m and the data-images d represents subset similar to the subset-images dₛₛₒ from the PET-image, and is therefore referred to as subset-models mₛₛ and subset-images dₛₛ.

### The Forward Problem

The method relies on an understanding of the physical process that generates the observed PET image, d_{obs}, including blurring and noise. Say, the model m represent the in situ distribution of tracer intensity. Then the image d, one will obtain, can be computed through the following process:

$$d = g ( m ) + n ( m ) , \qquad ( 2 )$$

wherein ‘g’ represents a function that applies blurring or smoothing, according to the used scanner and reconstruction method, and ‘n’ represent a function that generates noise according to a specific noise model. d represent one example of an image that would be observed for a specific model m.

For a localized subset-image dₛₛ, this is

$${d}_{ss} = g ( {m}_{ss} ) + n ( {m}_{ss} ) ,$$

where mₛₛ is an in situ distribution of tracer intensity for the localized subset-image dₛₛ.

‘g’ represent the blurring or smoothing introduced by using a specific type of scanner and reconstruction method, and is related to the point spread function. This is typically represented by a linear operator G_{PSF}, such that the forward problem can be described by

$$d = {G}_{PSF} ( m ) + n ( m ) . \qquad ( 3 )$$

or for a localized subset-image

$${d}_{ss} = {G}_{PSF} ( {m}_{ss} ) + n ( {m}_{ss} ) .$$

In practice, a noise model can be obtained by scanning a known target and computing the residual between the obtained PET image from the PET scanner and the PET image computed through G_{PSF}(m). The residual then represents one realization of the noise, from which a statistical model of the noise can be inferred. Similarly, the averaging function G_{PSF}(m) can be obtained by analysing the residual between the obtained PET image and the known target. Typically, the averaging function and the noise model will be estimated simultaneously.

Therefore, if the subset-model mₛₛ is known, a subset-image dₛₛ can be calculated. However, in the invention, the subset-model mₛₛ for the PET image is not known, but in the invention from the PET image, the subset-image dₛₛₒ is known. Therefore, a method to determine the subset-model mₛₛ, or a characteristic of a subset-model mₛₛ, from the subset-image dₛₛₒ is required. To be able to find characteristic of a subset-model mₛₛ a machine learning system is generated and trained.

### The Prior ρ(m)

To obtain a machine learning system to solve the inverse problem starting with a PET image d_{obs} and ending up with output data, the first step is to generate data for training the machine learning system. To do this the collected expert data is used to represent a prior ρ(m). The prior represents prior knowledge about the model parameters. This may come from expert knowledge, previous surveys and similar sources. The output data, called the representation output, generated by the machine learning system may be an image or it may be statistical data, estimating a characteristic of the PET image.

An expert, for instance a doctor working with diagnosing cancer from PET images, can make expert data, usually in cooperation with a data specialist. The expert creates or selects, for instance, a set of images for the expert data. The images the expert selects can be images from humans showing tumours or metastases or other kinds of relevant cell structures. Based on the expert data a data specialist generates a statistical model, representing the prior information, describing the variation in these images. Alternatively, the data specialist can generate the prior from previous surveys, an assumed statistical model, or other data sources.

Methods to quantify and sample from a prior using spatial correlations is described in the references:
Deutsch, C. V., & Journel, A. G. (1992). Geostatistical software library and user's guide. New York, 119(147).
Mariethoz, G., & Caers, J. (2014). Multiple-point geostatistics: stochastic modelling with training images. John Wiley & Sons.

The prior ρ(m) does not need to exist as a mathematical model (while it can) but is instead represented by the choice of algorithm and statistical model. The explicit choice of prior information is then quantified through the realizations generated by the algorithm and statistical model of choice.

### The Sample M*, Model-Images m* and Data-Images d*

Example images are generated as realizations of the prior and are called model-images, denoted by mₛₛ*, and they form the sample M*. When completed the sample M* comprises a large number of model-images mₛₛ*, distributed according to ρ(m). The sample M* includes a high number of model-images mₛₛ*. The sample M* can include 1000 or 10000 or 100000 or any other suitable numbers of model-images mₛₛ*.

mₛₛ* denotes a model-image from the sample M*, which is a realization from the prior. The model image mₛₛ* is in principle an image without noise or blur.

For each model-image mₛₛ* the corresponding noise-free data-image dₛₛ* is computed by evaluating the forward model (equation 3)

$${d}_{ss}^{*} = {G}_{psf} ( {m}_{ss}^{*} )$$

By adding noise to the data-image dₛₛ*, through the noise model n, a sim-data-image d_{ss,sim}* is obtained

$${d}_{ss , sim}^{*} = {G}_{psf} ( {m}_{ss}^{*} ) + n ( {m}_{ss}^{*} ) .$$

dₛₛ* denotes a data-image based on the model-image mₛₛ*. The data-images dₛₛ* form the data sample D*. The sim-data-image d_{ss,sim}* is obtained from further adding noise to the data-image dₛₛ*. The sim-data-images d_{ss,sim}* form the simulated data sample Dₛᵢₘ*.

A data-image dₛₛ* is a smoothed version of the original model-image mₛₛ*, as quantified through the smoothing operator g or G_{PSF}. The data-image dₛₛ* is a representation of model-image mₛₛ* to which blur is added. The sim-data-image d_{ss,sim}* is a representation of the model-image mₛₛ* to which both blur and noise has been added.

A model-image mₛₛ* can represent Nm pixels, which may be the same number of pixels as the data-image dₛₛ*, the sim-data-image d_{ss,sim}* and the subset-image dₛₛₒ represents, but also the model-image mₛₛ can have more pixels than the data-image dₛₛ*, the sim-data-image d_{ss,sim}*, and the subset-image dₛₛₒ. That is the model-image mₛₛ* can be represented using finer or more coarse resolution than the resolution of the data-image dₛₛ* and the sim-data-image d_{ss,sim}* so that the model-image mₛₛ* have more pixels than the data-image dₛₛ.

A model-image mₛₛ*, as well as a data-image dₛₛ*, a sim-data-image d_{ss,sim}*, and a subset-image dₛₛₒ, is a representation of a small image including 1 pixel, or 10 or 100 or 1000 or any other suitable number of pixels. The pixels can be placed in a 3-dimensional configuration for instance in an image of 9×9×9 pixels or a 2-dimensional configuration for instance in an image of 9×9 pixels.

The number of pixels represented in a model-image mₛₛ*, a data-image dₛₛ*, a sim-data-image d_{ss,sim}*, and a subset-image dₛₛₒ will be denoted nₚ. A model-image mₛₛ*=[mₛₛ₁, mₛₛ₂, . . . , mₛₛₙ] is a vector representing nₚ model parameters representing the real tracer intensity in the nₚ pixels. That is, if the model-image mₛₛ* represents an image of for instance 9×9 pixels, a total of 81 pixels, and the model-image mₛₛ* is therefore in this example a vector with nₚ=81. Likewise for the subset-image dₛₛₒ, the sim-data-image d_{ss,sim}* and the data-image dₛₛ*.

Models generated from the prior are referred to as model-images mₛₛ*, and data-images generated from the model-images mₛₛ* by using the forward model, are referred to as data-image dₛₛ*, if they are without noise, and as sim-data-images d_{ss,sim}*, if they are including noise.

The set of generated sim-data images, d_{ss,sim}*, form the simulated data sample Dₛᵢₘ*. When completed the simulated data sample Dₛᵢₘ* comprises a large number of sim-data-images d_{ss,sim}*, as many as model images, denoted by mₛₛ*, in M*.

The sim-data-images d_{ss,sim}* are used to train a machine learning system and the trained machine learning system is then used to analyse a PET scan by estimating properties of σ(mₛₛ) from localized subset-images dₛₛₒ of the PET scan.

### The Machine Learning System

When creating training sets comprising sim-data-images d_{ss,sim}*, a mapping is made from the sim-data-image d_{ss,sim}* to the model-image mₛₛ* or from the sim-data-image d_{ss,sim}* to a characteristic of the model-image mₛₛ*, the mapped characteristic of the model image mₛₛ* is an expected output m_{f}* for the machine learning system. Thereby, the training sets each comprises a sim-data-image d_{ss,sim}* and an expected output m_{f}*.

The expected output sample M_{f}* is the collection of all the expected outputs m_{f}*. The training data [Dₛᵢₘ*; M_{f}*] is the collection of all the training sets [d_{ss,sim}; m_{f}*]. The training data [Dₛᵢₘ*; M_{f}*] is used to train the machine learning system to learn a mapping from the simulated data sample Dₛᵢₘ* to the expected output sample M_{f}*.

During training the machine learning system, the characteristic expected output m_{f}* may be identical to the model-image mₛₛ*, but the characteristic expected output m_{f}* may also be a subset of the model-image mₛₛ*, for instance the intensity of the central pixel in the model-image mₛₛ* or a probability that the central pixel belongs to a certain category, for instance the category “cancer”. The characteristic m_{f}* is the expected output from the machine learning system when the sim-data-image d_{ss,sim}* is the input. The expected output m_{f}* may also be a statistical function for example a normal distribution, where the expected output m_{f}* is a vector with two values, the mean and the covariance for a normal distribution for instance describing the probabilities for pixel intensities.

When the machine learning system is trained, the output mₒ generated by the machine learning system is compared to the expected output m_{f}*. During training the output mₒ are determined for all sim-data-images d_{ss,sim}* in the training set and compared to the expected output m_{f}*. The machine learning system is trained to minimize the difference between the output mₒ and the expected output m_{f}* according to a cost function C(m_{f}*, mₒ). When the cost function is minimized, the training is completed.

The cost function is typically chosen to represent the log-likelihood of the feature one which to estimate. If m_{f}* represent the mean and covariance, N(m_{0f}*, C_{f}*), for a set of pixel in a model image, then minimizing the following cost function,

$$C ( {m}_{f}^{*} , {m}_{o} ) = - 0.5 ( ( {m}_{0 f}^{*} - {m}_{o} ) {C}_{f}^{* - 1} {( {m}_{0 f}^{*} , {m}_{o} )}^{′} ) ,$$

will lead to estimation of the posterior mean and covariance of σ(m_{f}*). If m_{f}* represent the probability of a certain outcome, the use if the categorical cross entropy will to a lead to a full description of (m_{f}*).

An introduction of machine learning, and the use of cost functions is described e.g.:
Bishop, Christopher M. Pattern, Recognition and machine learning. Springer, 2006.

The PET image is analyzed by the machine learning system and reconstructed by analyzing each subset-image dₛₛₒ extracted from the PET image. The trained machine learning system, when analyzing subset-images dₛₛₒ from a PET image, is determining a mapping from each subset-images dₛₛₒ to the subset-model mₛₛ, or a mapping from the subset-images dₛₛₒ to a characteristic of the subset-model mₛₛ.

The trained machine learning system is receiving the subset-images dₛₛₒ as input. The trained machine learning system evaluates the subset-images dₛₛₒ one at a time, and for each subset-image dₛₛₒ, an output mₒ is generated. The output mₒ can represent the full subset-model mₛₛ, or a characteristic of the subset-model mₛₛ. The subset-model mₛₛ may never be determined in full, the machine learning system is determining a characteristic of the subset-model mₛₛ, like for instance the intensity of the central pixel, or a group of central pixels of subset-model mₛₛ based on the subset-image dₛₛₒ.

The output mₒ may be a numerical value, which may be the intensity of a pixel, or the intensities of a group of pixels in the subset-model mₛₛ. The output mₒ may be a numerical value for the number of pixels connected to the central pixel in the subset-model mₛₛ, which is indicating cancer, or which have a pixel intensity higher than a threshold pixel probability.

Alternatively, the output mₒ may be a category, it may be in a category A, if a condition is fulfilled or in a category B, if a condition is not fulfilled, or it may be a probability that it is in category A and a probability that it is category B. The output mₒ may be probability values for a number of categories. There may be two or more categories, where a probability is given for each category. Category A may be the probability for “cancer” and Category B may be the probability for “no cancer”.

The output mₒ may also represent a statistical function for example a normal distribution, where the output mₒ is a vector with two values, the mean and the variance for a normal distribution for instance describing the probabilities for pixel intensities. mₒ could also represent the mean and covariance of a multivariate normal distribution.

Thus, the described objects of the invention and several other objects are intended to be obtained in a first aspect of the invention by providing a computer-implemented method for image analysis and reconstruction for medical imaging of a subject, the method is comprising:
obtaining a PET image and dividing the PET image into a plurality of subset-images dₛₛₒ, each subset-image dₛₛₒ is a representation of one, or more, pixels,
providing a trained machine learning system,
applying the subset-images dₛₛₒ as input for the trained machine learning system,
obtaining a output mₒ for each subset-image dₛₛₒ from the machine learning system,
determining and outputting a representation output based on the outputs mₒ.

Each subset-image dₛₛₒ from the PET image is now processed by the machine learning system. For each subset-image dₛₛₒ, an output mₒ is obtained and based on a plurality of output mₒ obtained for the plurality of analysed subset-images; a representation output is determined and outputted. The representation output may be an image or it may by a file of statistical data.

Accordingly, providing a trained machine learning system is comprising:
obtaining a model-image mₛₛ* from a sample M*, the model-image mₛₛ* is a realization from a prior ρ(m), the prior ρ(m) is a statistical model based on expert prior data, each model-image mₛₛ* is a representation of an image of one, or more, pixels,
obtaining training sets, each training set comprises a sim-data-image d_{ss,sim}* and an expected output m_{f}*, by determining the sim-data-image d_{ss,sim}* based on the model-image mₛₛ*, and selecting the expected output m_{f}* based on the model-image mₛₛ* for each sim-data-image d_{ss,sim}*, each sim-data-image d_{ss,sim}* is a representation of one, or more, pixels,
applying the training sets as input for training the machine learning system, and obtaining an output mₒ for each sim-data-image d_{ss,sim}* from the machine learning system, and
training the machine learning system until the machine learning system converges based on comparing the outputs mₒ with the expected outputs m_{f}*.

The machine learning system is trained by using training sets. The training sets are generated by obtaining a sim-data-image d_{ss,sim}* and an expected output m_{f}*. For each model-image mₛₛ*, which is a realization from the prior (m), a sim-data-image d_{ss,sim}* is generated by the formula d_{ss,sim}*=g(mₛₛ*)+n(mₛₛ*), where g(mₛₛ*) may be the function G_{psf}(mₛₛ*).

The sim-data-image d_{ss,sim}* is used as input to training the machine learning system. Further, an expected output m_{f}* is input to the machine learning system. The expected output m_{f}* is generated from the model-image mₛₛ* and is a characteristic of the model-image mₛₛ*, it may be the intensity of the central pixel, or may be a number representing a number of pixels connected to the central pixel, which is an indication a probability for cancer, or which have an pixel intensity higher than a threshold pixel intensity.

Alternatively the expected output m_{f}* may be the posterior probability of a category derived from the model-image mₛₛ*. There may be a category A for the probability that the model-image mₛₛ* is showing “cancer” and a category B for the probability that the model-image mₛₛ* is showing “not cancer”. There may be more than two categories.

The machine learning system converges when a cost function for the training sets for the machine learning system is minimized. The cost function is based on comparing the outputs mₒ with the expected output m_{f}*.

Typically, a part of the training data is removed, and referred to as test data set. The machine learning system is trained on the training data [Dₛᵢₘ*; M_{f}*], and compared to performance on the test data set, in order to ensure the machine learning system will perform well on new data.

Training sets are obtained by generating model-images mₛₛ* from the prior (m) and by using the forward model to generate sim-data-image d_{ss,sim}* from the model-image mₛₛ*, and a training set is obtained by further generating an expected output m_{f}* based on the model-image mₛₛ*. Each training set therefore comprises a sim-data-image d_{ss,sim}* and a corresponding expected output m_{f}*.

The training sets may be stored in a table [Dₛᵢₘ*; M_{f}*], which then is the training data. The table may further be saved in a data storage, for instance in a database, and may be saved for future use, so that the training data may be reused for training another machine learning system.

For instance, a table may be generated with a number of different expected outputs for each sim-data-image d_{ss,sim}*. So that the expected output used for training depends on what kind of analysis is required.

Accordingly, wherein providing a trained machine learning system is comprising:
selecting the trained machine learning system from a plurality of trained machine learning systems based on the type of the output mₒ to be obtained.

There may be several trained machine learnings systems saved on or available to a computer, and then based on the desired output to be obtained, the computer selects which of the trained machine learning system to apply.

Accordingly, the method further is comprising that the sim-data-image d_{ss,sim}* is determined from the model-image mₛₛ* by the function of the type d_{ss,sim}*=g(mₛₛ*)+n(mₛₛ*), wherein g is a smoothing function and n is a noise function.

The sim-data-image d_{ss,sim}* for the training set is determined from the model-image mₛₛ* and the expected output m_{f}*, depending on which kind of output is required.

Accordingly, the method further is comprising that the selected expected output m_{f}* is the pixel intensity of the central pixel or a group of central pixels, in the model-image mₛₛ*, or a probability of a certain feature related to the model-image mₛₛ*.

One kind of expected output m_{f}* may be the pixel intensity of the central pixel in the model-image mₛₛ*. Alternatively, the expected output m_{f}* may be from a central group of pixels in the model-image mₛₛ*. For instance if the model-image mₛₛ* is comprising 9×9 pixels, the expected output m_{f}* may be the nine central pixel forming a 3×3 matrix around the central pixel. In this case, the expected output m_{f}* may be a vector of nine pixel intensities.

Accordingly, the method further is comprising that the selected expected output m_{f}* is the number of pixels connected to the central pixel with an intensity higher than a threshold intensity value or a probability of a disease, for instance cancer, higher than a threshold probability value.

The expected output m_{f}* may for example be the number of pixels connected to the central pixel having a pixel intensity of more than 12, when the intensity is given as a value between 0 and 20.

Accordingly, the method further is comprising that the expected output m_{f}* is the category of the central pixel, or a group of pixels, in the model-image mₛₛ* or the expected output m_{f}* is a probability for one or more categories.

The expected output m_{f}* may be a vector of one or more categories where a category A for instance may be the probability that the model-image mₛₛ* represent cancer and a category B may be the probability that the model-image mₛₛ* do not represent cancer.

Accordingly, the method further is comprising that the expected output m_{f}* (21) is a vector with two values, the mean and the covariance for a normal distribution.

### Representation Outputs

When a plurality of the subset-images dₛₛₒ has been processed by the machine learning system, then the plurality of outputs mₒ, one output mₒ for each subset-images dₛₛₒ, from the machine learning system are used to determine representation outputs of the data.

Accordingly, determining a representation output comprises ordering the outputs mₒ according to the location of the subset-images dₛₛₒ in the original PET scan.

Accordingly, the method further is comprising that the output mₒ is a numerical value like a pixel intensity, or a mean value and covariance for a number of pixels, or a number of pixels or the expected output mₒ is a category or a probability for one or more categories.

The output mₒ of the machine learning system may be a pixel intensity for one pixel, or it may be pixel intensities for several pixels, for instance the 9 central pixels. Alternatively, the output mₒ may be a mean value and a covariance for a number of pixels. The output mₒ may be a number of pixels for how many pixels have an intensity higher than a threshold intensity. The output mₒ may be a category, for instance the category “cancer” or a category “not cancer”. mₒ may be a single value or it may be a vector of two or more values. For instance, the output mₒ may be a vector with probabilities for two or more categories.

If the outputs mₒ is a numerical value, for instance a pixel intensity or the mean pixel intensity, the outputs can be used to generate an image of higher quality of the original PET scan, a cleaned up version of the PET scan.

Accordingly, the method further is comprising that the outputs mₒ are ordered into a representation output.

Obviously, the representation output can be determined in many different ways by using many different statistical calculation methods.

If the outputs mₒ is an intensity value, then a cleaned up version of the PET scan can be constructed. This cleaned up image is the model mᵣₑₛₜₒᵣₑ and is the solution to the inverse problem of constructing a cleaned up image form the original PET image d_{obs}.

If the outputs mₒ is a number of how many pixels with high probability of cancer is connected, representing the volume/area of a cancer lesion, then an representation output will be created where many connected pixels with high cancer probability will be darker in the representations output image than when only few pixels are connected or only a single pixel are having a high cancer probability. The same will be the case if the outputs mₒ is a number of how many pixels with high intensity is connected.

When the output mₒ is categories, the output mₒ may be a vector with two or more numbers; the numbers may be a probability for each category. Then a representation output may be made for probability for one of the categories. If the category is the probability of cancer, a representation output image is made with a dark pixel for high probability and less dark pixel for lower probabilities and a white pixel in case the probability is zero. Such a representation output is emphasizing the risk of cancer.

When the subset-image dₛₛₒ is selected from the PET image, not only a single pixel is chosen, but a group of pixels. This is because using G_{PSF} the pixel intensity for a single pixel is dependent on the intensity and noise of the neighbor pixels, therefore some rows of neighbor pixels are needed for getting the right result for the single pixel. Therefore, a method to make subset-images dₛₛₒ by moving the frame around the subset-image dₛₛₒ only one pixel at a time, making a subset-image dₛₛₒ for each pixel in the PET image, so the subset-image dₛₛₒ, for instance, can be 9×9 pixels. The centre pixel is surrounded by the neighbour pixels in the subset-image dₛₛₒ, but when the subset-image dₛₛₒ is analyzed for instance only the intensity of the center-pixel of the corresponding subset-model mₛₛ is used and the other 80 pixels around the center pixel is ignored. The output m_{f}* may be the intensity of the central pixel of the subset-model mₛₛ and the representation output image is then put together with all the central pixel values of the subset-models mₛₛ ordered in the same order as the subset-images dₛₛₒ in the original PET image to form a cleaned up PET image.

For a subset-image of 9×9 pixels, the calculation gives the correct center pixel value in the given case. Using a larger subset-image, more of the center pixel can be used, and hence potentially lead to increased efficiency. Increased efficiency will depend on the increased computational demands to set up and train the machine learning system.

Accordingly, the machine learning system comprises a regression type mapping, when the expected output m_{f}* represent a numerical value, or a classification type mapping, when the expected output m_{f}* represent a category.

When creating the machine learning system by using a neural network, the last layer in the neural network differs depending on whether the expected output m_{f} refer to a continuous value, for instance pixel intensity, or whether it refer to discrete parameter, or the probability value for a specific category. When a continuous value is required, the last layer is a regression layer. When probabilities for different categories are required, the last layer is a classification layer.

Accordingly, the machine learning system comprises a neural network.

The machine learning system preferable is a neural network, but may alternatively be decision trees or support vector machines or any other machine learning algorithm able to learn the mapping from Dₛᵢₘ* to M_{f}*.

Specifically the machine learning system may be using a feed forward neural network, consisting of a number of layers, where the input layer consist of a number of neurons corresponding to the number of parameters in the subset-image dₛₛₒ, which more specific is the number of pixels in the subset-image dₛₛₒ, each pixel represented by the pixel intensity. In principle, any network architecture can be used as long is the input layer reflect s the subset-image dₛₛₒ, and the output layer reflect the expected output m_{f}*.

The output layer consist of one or more neurons, one for each element in the output mₒ. The output layer may be a single neuron with the value of the output mₒ, or it may be two or more neurons, each representing a category and is a probability value for the given category. The number of layers in the neural network depends on which output is required. The number of layers and nodes is selected high enough that the mapping between the subset-image dₛₛₒ and the expected output m_{f} can be resolved, and low enough that training of the network does not lead overfitting of the training data.

Back propagation is used to calculate weights and biases for the neural network and the ADAM algorithm can, for example, be used for changing weights and biases. The ADAM algorithm is a standard optimization algorithm available for instance through tensorflow.
Kingma, Diederik P., and Jimmy Ba. “Adam: A method for stochastic optimization.” arXiv preprint arXiv: 1412.6980 (2014).

The invention relates to a computer program product comprising at least one computer having data storage means in connection therewith, and the computer program comprising instructions which, when the program is executed by a computer, cause the computer to carry out the steps of the method of the image reconstruction.

Accordingly, to a second aspect of the invention, the invention relates to a method for training a machine learning system for image reconstruction, the method is comprising:
obtaining a model-image mₛₛ* (16) from a sample M* (14), the model-image mₛₛ* (16) is a realization from a prior ρ(m) (12), the prior ρ(m) (12) is a statistical model based on expert prior data, each model-image mₛₛ* (16) is a representation of an image of one, or more, pixels,
obtaining training sets, each training set comprises a sim-data-image d_{ss,sim}* (18) and an expected output m_{f}* (21), by determining the sim-data-image d_{ss,sim}* (18) based on the model-image mₛₛ* (16), and selecting the expected output m_{f}* (21) based on model-image mₛₛ* (16) for each sim-data-image d_{ss,sim}* (18), each sim-data-image d_{ss,sim}* (18) is a representation of one, or more, pixels,
applying the training sets as input for training the machine learning system (36), and obtaining a output mₒ (34) for each sim-data-image d_{ss,sim}* (18) from the machine learning system, and
training the machine learning system until the machine learning system converges based on comparing the outputs mₒ (34) with the expected outputs m_{f}* (21).

Accordingly, to a third aspect of the invention, the invention relates to a medical imaging system comprising a scanner (112) and a control system (111) for scanning and recording a PET image, and a processor, wherein the processor is configured to:
obtain a PET image and divide the PET image into a plurality of subset-images dₛₛₒ, each subset-image dₛₛₒ is a representation of one, or more, pixels,
provide a trained machine learning system, and apply the subset-images dₛₛₒ is the input for the trained machine learning system,
obtain a output mₒ for each subset-image dₛₛₒ from the machine learning system,
determine and output a representation output based on the outputs mₒ.

Further, accordingly to the third aspect of the invention, the invention relates to a medical imaging system, wherein the processor is further configured to provide a trained machine learning system by:
obtaining a model-image mₛₛ* from a sample M*, the model-image mₛₛ* is a realization from a prior ρ(m), the prior ρ(m) is a statistical model based on expert prior data, each model-image mₛₛ* is a representation of an image of one, or more, pixels,
obtaining training sets, each training set comprises a sim-data-image d_{ss,sim}* and an expected output m_{f}*, by determining the sim-data-image d_{ss,sim}* based on the model-image mₛₛ*, and selecting the expected output m_{f}* based on the model-image mₛₛ* for each sim-data-image d_{ss,sim}*, each sim-data-image d_{ss,sim}* is a representation of one, or more, pixels,
applying the training sets as input for training the machine learning system, and obtaining an output mₒ for each sim-data-image d_{ss,sim}* from the machine learning system, and
training the machine learning system until the machine learning system converges based on comparing the outputs mₒ with the expected outputs m_{f}*.

In an aspect of the invention, the invention relates to a computer program product being adapted to enable a computer system comprising at least one computer having data storage means in connection therewith to control a medical image system, such as a computer program product comprising instructions which, when the program is executed by a computer, cause the computer to carry out the method of the invention.

This aspect of the invention is particularly, but not exclusively, advantageous in that the present invention may be accomplished by a computer program product enabling a computer system to carry out the operations of the method of the image reconstruction of the invention when down- or uploaded into the computer system. Such a computer program product may be provided on any kind of computer-readable medium, or through a network.

The individual aspects of the present invention may each be combined with any of the other aspects. These and other aspects of the invention will be apparent from the following description with reference to the described embodiments.

### BRIEF DESCRIPTION OF THE FIGURES

The method according to the invention will now be described in more detail with regard to the accompanying figures. The figures show one way of implementing the present invention and is not to be construed as being limiting to other possible embodiments falling within the scope of the attached claim set.

FIG. 1 illustrates a schematic drawing of a medical imaging system.

FIGS. 2a and 2b illustrates a 2D observed PET image and a subset-image from the PET image.

FIG. 3 illustrates when the machine learning system is running, it takes subset-images dₛₛₒ as input and the output is the outputs mₒ.

FIG. 4 illustrates the forward model by a reference model m_{ref}, a smoothed model, and the a smoothed model with noise, representing a PET image.

FIG. 5 illustrates how to generate model-images mₛₛ* from expert data.

FIG. 6 illustrates how to generate a training set.

FIG. 7 illustrates training the machine learning system.

FIG. 8 illustrates an example of six training sets for training the machine learning system for three different features.

FIG. 9 illustrates another example of six training sets for training the machine learning system.

FIG. 10 illustrates a classification neural network using multilayer perception (MLP).

FIG. 11 illustrates another possible neural network implementation for the invention using a Convolutional Neural Network (CNN).

FIGS. 12a and 12b illustrates two possible representation output images based on the PET image in FIG. 2a, obtained using a MLP and CNN.

FIGS. 13a and 13b illustrates the determination of the pixel intensity for a single pixel in the ideal reference model m_{ref}.

FIG. 14 illustrates the representation output image obtained using a CNN neural network and the representation output image obtained using a MLP neural network.

FIG. 15 illustrates representation output images when the output mₒ comprise two values, a mean and a covariance so that the output mₒ represents a normal distribution.

The figures show one way of implementing the present invention and is not to be construed as being limiting to other possible embodiments falling within the scope of the attached claim set.

### DETAILED DESCRIPTION OF AN EMBODIMENT

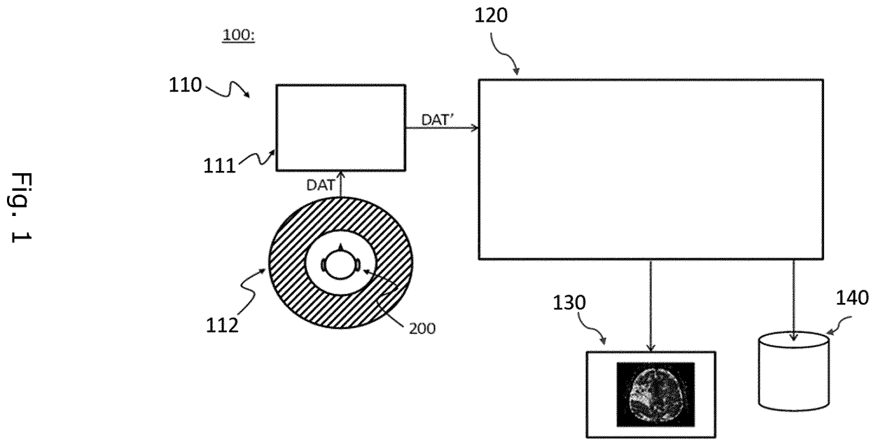

FIG. 1 is a schematic drawing of a medical imaging system 100 in an aspect of the present invention. The system 100 comprises a scanning system 110, capable of obtaining data representative of a contrast agent concentration as a function of time of an injected contrast agent into a human 200, whose head is schematically seen in a cross-sectional view. One or more parts of the human can be imaged, e.g. the brain. The system comprises a PET scanner 112 and a corresponding measurement and control system 111. The scanner obtains primary data DAT which are communicated to the measurement and control system 111, where further processing resulting in secondary data DAT′ being communicated to a processor 120.

In the processor 120, a method for estimating perfusion indices for the human 200 is implemented using the obtained data DAT and DAT′ representative of a contrast agent concentration as a function of time of an injected contrast agent.

The processor may be operably connected to a display device 130, such as a computer screen or a monitor, to enable showing an image of the resulting PET image as schematically indicated. Alternatively, or additionally, the PET image may be communicated to a storage device 140 of any suitable kind for later analysis and diagnostic purposes.

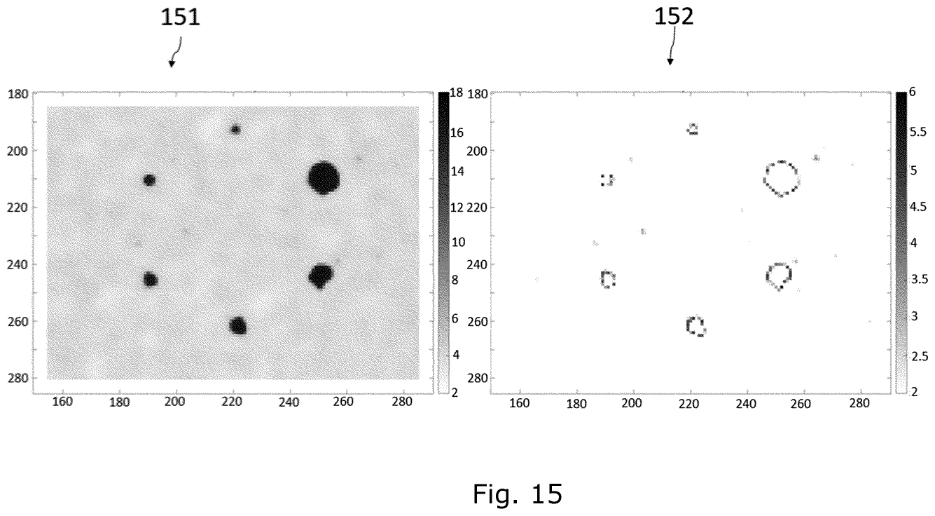

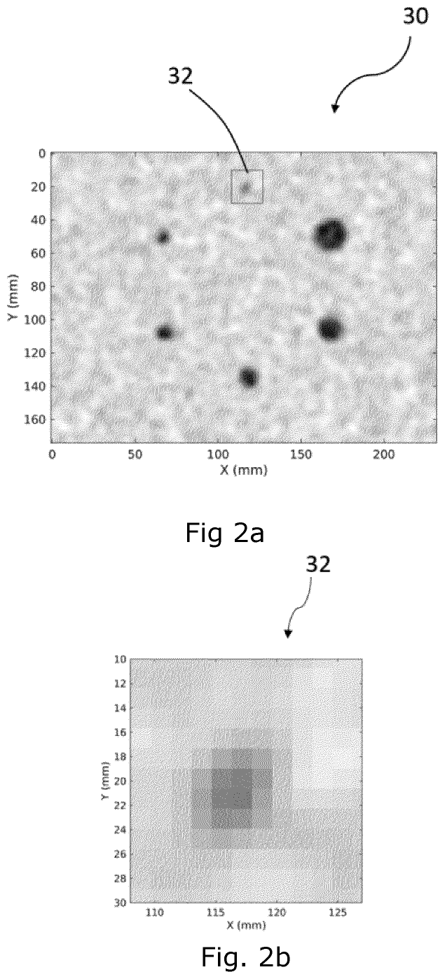

FIG. 2a shows a 2D PET image, as output from a PET scanner. The 2D PET image is an example of a PET image 30. On FIG. 2b one subset-images dₛₛₒ 32 is shown in a marked square where each tracer intensity of the subset-images dₛₛₒ 32 is shown as a pixel representing the tracer intensity. This subset-image dₛₛₒ 32 representation has 11×11 pixels. According to the method of the invention, the PET image 30 is divided into a plurality of subset-images dₛₛₒ 32. In the preferred embodiment a subset-image may be created for each pixel in the PET image, so that each pixel will be the central pixel in a subset-image dₛₛₒ 32 surrounded by the neighbor pixels to form a subset-image dₛₛₒ 32, which may be a 11×11 pixels image as shown in FIG. 2b.

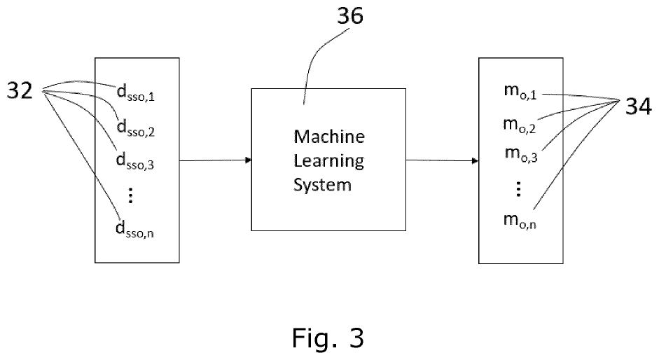

FIG. 3 illustrates that when the machine learning system 36 is running, it takes subset-images dₛₛₒ 32 as input and outputs the outputs mₒ 34. The machine learning system 36 analyses one subset-image dₛₛₒ 32 at a time and outputs an output mₒ 34. The subset-images dₛₛₒ 32 and the output mₒ 34 are ordered, it may be in a table or in a database, according to the location of the subset-image dₛₛₒ in the original PET image so that the outputs mₒ can be arranged to form a representation output image.

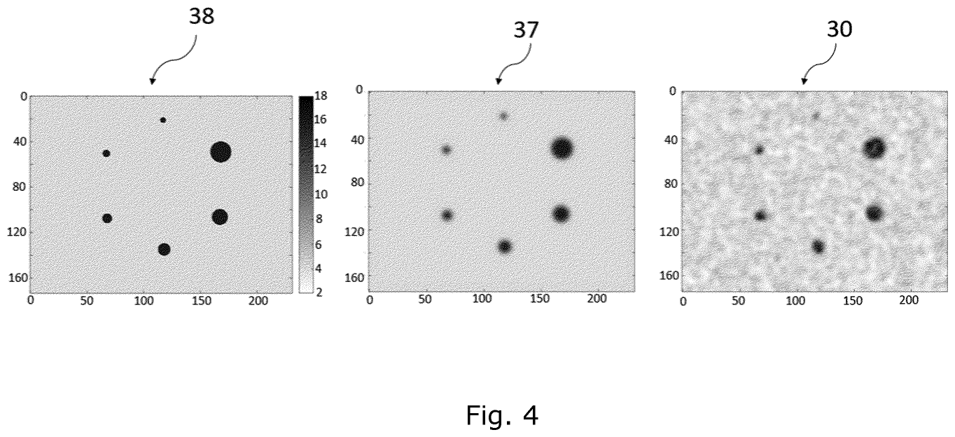

FIG. 4 illustrates the forward model. The image 38 in FIG. 4 is an example of a reference model m_{ref} 38 for the PET image d_{obs} 30. The reference model is the image as it would look like completely without noise or blur. The image 37 shows the forward response d_{ref}=G_{psf}(m_{ref}). The image 30 is the PET image d_{obs}, which is a realisation of the noise model d_{obs}=G_{psf}(m_{ref})+n(m_{ref}).

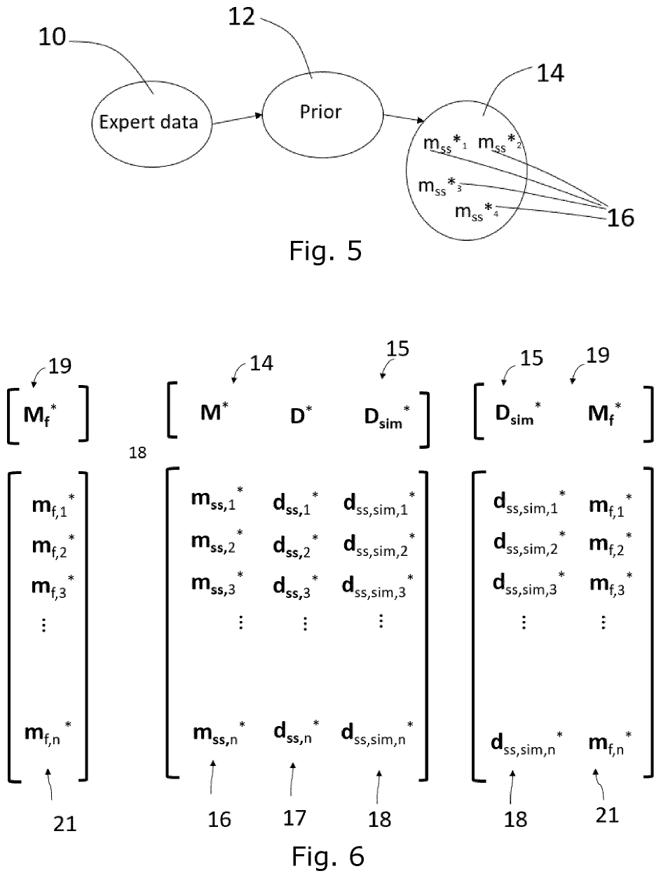

FIG. 5 illustrates how to generate model-images mₛₛ* 16 from expert data 10. When generating a training set, the prior ρ(m) 12 is generated based on expert data 10, the sample M* 14 is created from the prior ρ(m) 12 containing model-images mₛₛ* 16 which is realizations from the prior ρ(m) 12.

FIG. 6 illustrates how to generate a training set. From the model-images mₛₛ* 16 in the sample M* 14, a data-image dₛₛ* 17 and a simulated sim-data-image d_{ss,sim}* 18 is determined, which is done by the functions dₛₛ*=g(mₛₛ*) and d_{ss,sim}*=g(mₛₛ*)+n(mₛₛ*). From the model-images mₛₛ* 16 also expected outputs m_{f}* 21 are determined. A sim-data-image d_{ss,sim}* 18 and an expected output m_{f}* 21 is forming a training set. The training sets may be saved in a table with two columns the simulated data sample Dₛᵢₘ* 15 and the expected output sample M_{f}* 19 as shown in FIG. 4, alternatively the training sets may be saved in a database or in another kind of data storage. It is also possible to generate alternative expected outputs, which then for example may be saved in additional columns in the table.

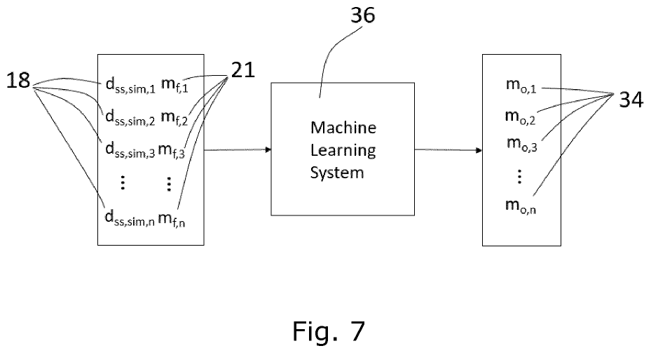

FIG. 7 illustrates training the machine learning system 36. The sim-data-images d_{ss,sim}* 18 and an expected outputs m_{f}* 21 are the training data used to train the machine learning system. The output is the output mₒ. The accuracy of the training is determined by comparing the output mₒ with the expected outputs m_{f}* If the accuracy is sufficient, and converges, then the training is completed. Otherwise, the training is continuing by changing the weights and the bias for the nodes in the neural network and running the training again.

FIG. 8 illustrates an example of six training sets for training the machine learning system, the training sets has been obtained by selecting model-images mₛₛ* 16 from the sample M*, which has been sampled from the prior ρ(m). The data-images dₛₛ* 17 are obtained from the model-images mₛₛ* 16 by the formula dₛₛ*=G_{psf}(mₛₛ*), and sim-data-images d_{ss,sim}* are obtained by the formula d_{ss,sim}*=G_{psf}(mₛₛ*)+n(mₛₛ*). The sim-data-images d_{ss,sim}* are then used as input for training of the machine learning system. For the training also an expected output m_{f}* is obtained. In FIG. 8 three examples of expected outputs m_{f}* (21a, 21b, 21c) are shown. In the first column the expected output m_{f}* (21a) is a category, which can be either “high” or “low” depending on the intensity of the central pixel. In the second column the expected output m_{f}* (21b) is an intensity value for the intensity of the central pixel in the model-image mₛₛ*. In the third column the expected output m_{f}* (21c) is 25 central pixels in the model-image mₛₛ* corresponding to one pixel in the data-image dₛₛ* and the sim-data-image d_{ss,sim}*. This is to be understood as the expected output m_{f}* is a vector of 25 intensity values representing the 25 central pixels in the model-image mₛₛ*. The number of pixels in the data-image dₛₛ* and the sim-data-image d_{ss,sim}* are reduced to minimize calculation time. But still the central pixels 25 in the model-image mₛₛ* may be the expected output m_{f}*.

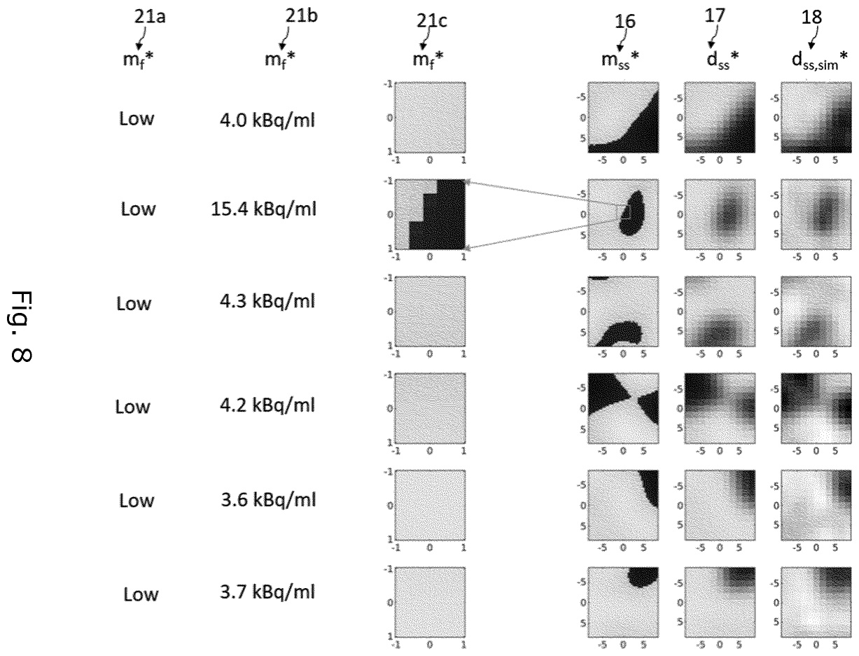

FIG. 9 shows further six training sets for training the machine learning system. In this case the pixels in the data-image dₛₛ* and the sim-data-image d_{ss,sim}* are each representing four pixels in the model-image mₛₛ*. Further the expected output m_{f}* vector 21c is a vector of nine central pixels in the model-image mₛₛ*.

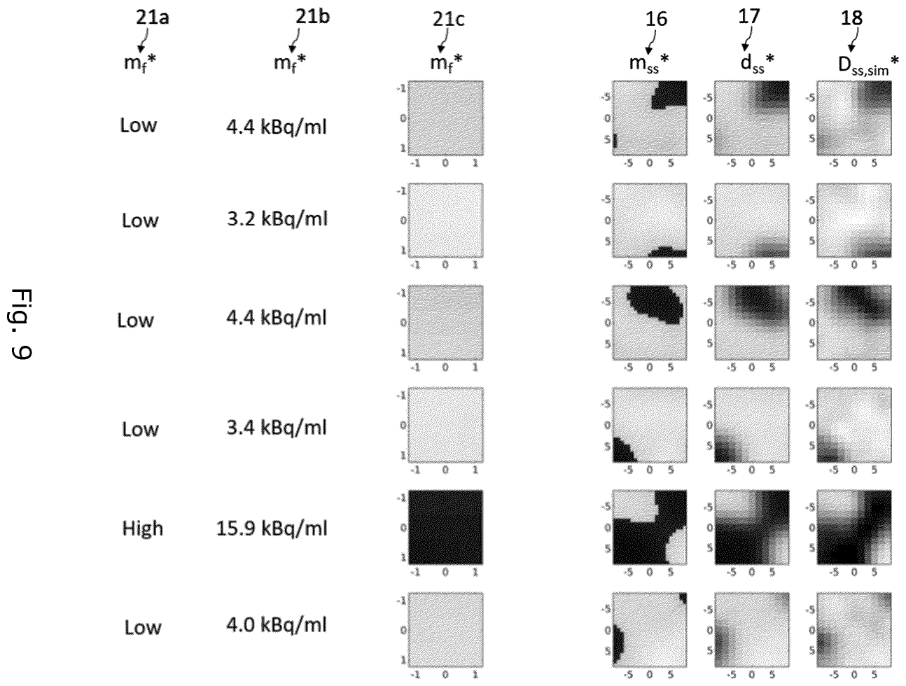

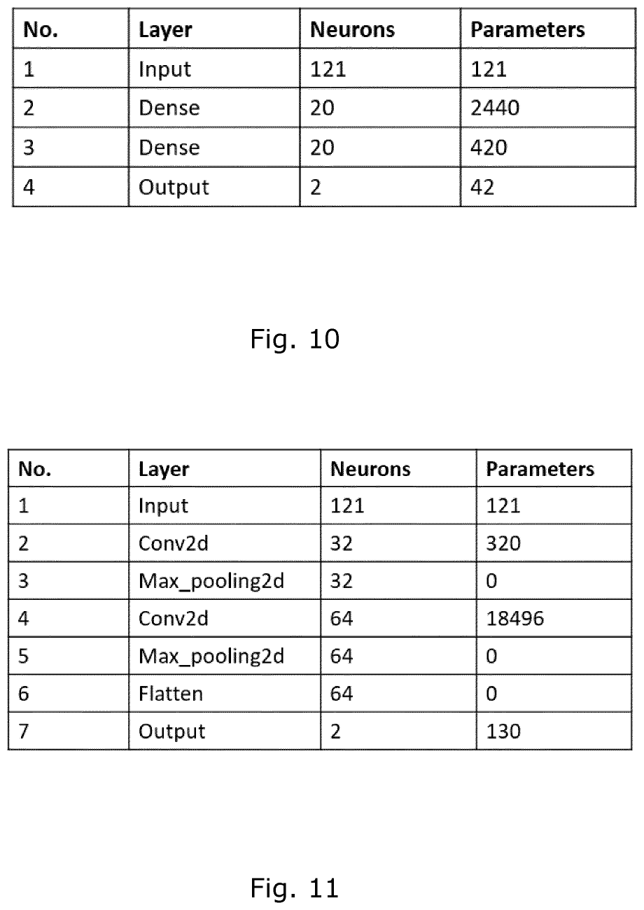

FIG. 10 illustrates a classification neural network using multilayer perception (MLP); this is one possible network configuration for the presented invention. The network comprises four layers; the first layer is the input layer, which in this case is a layer with 121 neurons. The input is the pixel intensities for each pixel in a subset-image dₛₛₒ with 11×11 pixels, which gives 121 pixel intensities. Each neuron in the input player represent a pixel of the subset-image dₛₛₒ and receives therefore an intensity value as input. Then the neural network comprises two hidden layers, layers 2 and 3, which each is a dense-layer of each 20 neurons, and the last layer is the output layer comprising two neurons, one neuron gives the probability for a first class, the other the probability for a second class. The first class may be the probability for cancer; the second class may be the probability for not cancer. The fourth column gives the no. of parameters used, and in total 2.902 parameters are used in this implementation.

FIG. 11 illustrates another possible neural network implementation for the invention using a Convolutional Neural Network (CNN). This is also a classification neural network; this neural network has seven layers. The first layer is the input layer, which also in this case comprises 121 neurons for pixel intensities in a subset-image dₛₛₒ with 11×11 pixels. The second layer is a folding layer (conv2d) with 32 neurons; the third layer is a pooling layer (max_pooling2d) with 32 neurons. The fourth layer is another folding layer (conv2d); this folding layer has 64 neurons. The firth layer is a pooling layer (max_pooling2d) with 64 neurons. The sixth layer is a flatten layer with 64 neurons, and finally the last layer is an output layer with two neurons, each neuron representing the probability of a class, like in FIG. 10. The fourth column gives the no. of parameters used, and in total 18.946 parameters are used in this implementation.

The implementations in FIGS. 10 and 11 are using standard routines, conv2d, Max_pooling2d, Flatten, and Dense for building neural networks. What is important for the invention is not how the specific neural network is build, as many different kinds of neural network can be used. Important for the application here is the input and output layers, as well as the used cost function.

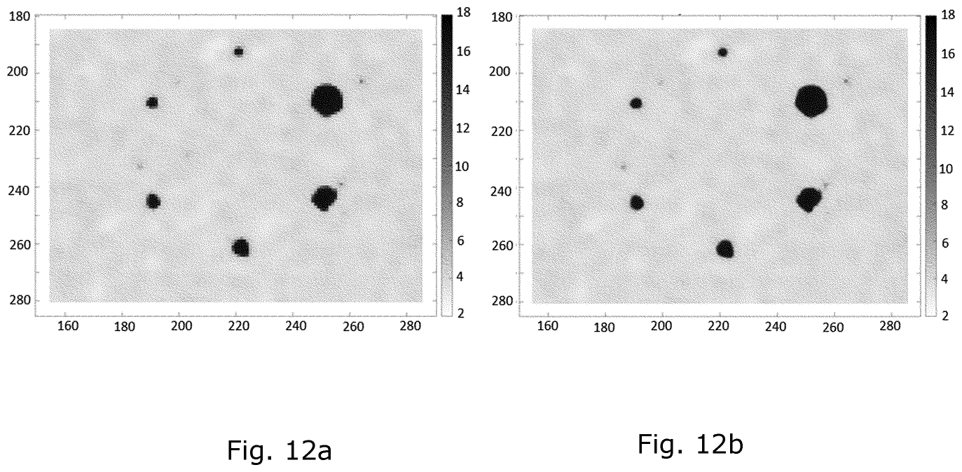

FIGS. 12a and 12b illustrates two possible representation output images based on the PET image in FIG. 2a. FIG. 12a shows a 1-1 representation, where each pixel in FIG. 12a represent a pixel in FIG. 2a. In FIG. 12b, each pixel in FIG. 2a is represented by 16 pixels, a 4×4 square in FIG. 12 b. This is in the case where the resolution of the model-images mₛₛ* is 16 times the resolution in the PET image.

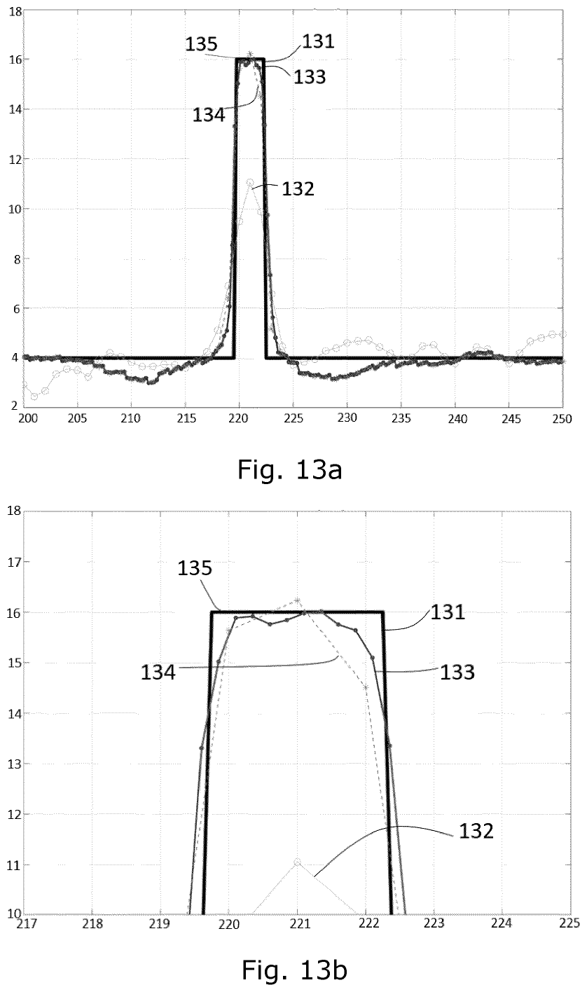

FIGS. 13a and 13b illustrates the determination of the pixel intensity 135 for the smallest high intensity region in the ideal reference model m_{ref}. FIG. 13b is a enlarged figure of a part of FIG. 13a. FIGS. 13a and 13b show a profile along the x-axis, for y=193 at FIGS. 12a and 12b. The ideal pixel value is illustrated by the line 131 and the line 132 illustrates the pixels values in the PET image d_{obs}. The pixel have a pixel intensity of 16 kBq/ml in the blurless and noiseless ideal reference model, but only about 10 kBq/ml in the original PET image with blur and noise. By the method of this invention the pixel intensity is determined according to line 133 for a machine learning system running with a finer scale than used in the PET image and according to line 134 for a machine learning system running with the same scale as is used in the PET image, showing that the result of the analysis of the machine learning systems are close to the pixel value of the ideal reference model.

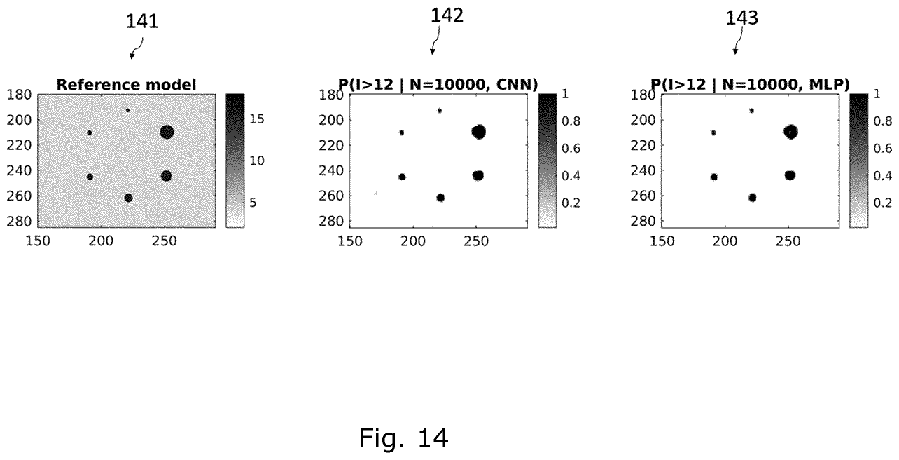

FIG. 14 illustrates the representation output 142 obtained using a CNN neural network and the representation output 143 obtained using a MLP neural network. The FIG. 141 is the ideal reference model m_{ref}, which is the PET image d_{obs} without blur an noise, showing that similar results are achieved whether using CNN neural network or using MLP neural network.

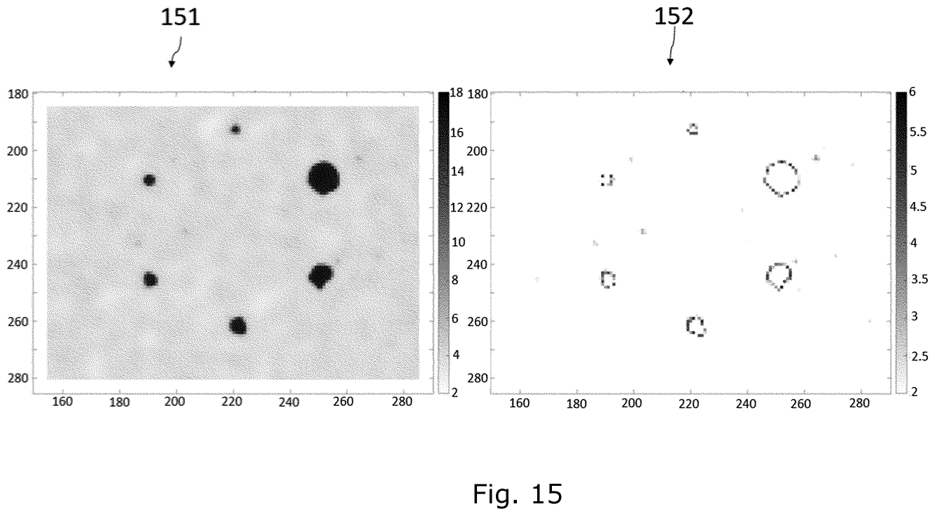

FIG. 15 illustrates representation output images when the output mₒ, for each subset-image dₛₛₒ, comprise two values, a mean and a variance so the output mₒ represents a normal distribution. The image 151 illustrates the mean for the plurality of outputs mₒ for the plurality of subset-image dₛₛₒ; each pixel in the image represents the mean for one output mₒ. The image 152 illustrates the corresponding variance for the plurality of outputs mₒ.

The invention can be implemented by means of hardware, software, firmware or any combination of these. The invention or some of the features thereof can also be implemented as software running on one or more data processors and/or digital signal processors.

The individual elements of an embodiment of the invention may be physically, functionally and logically implemented in any suitable way such as in a single unit, in a plurality of units or as part of separate functional units. The invention may be implemented in a single unit, or be both physically and functionally distributed between different units and processors.

Although the present invention has been described in connection with the specified embodiments, it should not be construed as being in any way limited to the presented examples. The scope of the present invention is to be interpreted in light of the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims may possibly be advantageously combined, and the mentioning of these features in different claims does not exclude that a combination of features is not possible and advantageous.

### Symbols:

m A model or a model-image
d A data-image related to m by d=g(m)+n(m)
d_{obs} The PET image
mᵣₑₛₜₒᵣₑ The model without noise or blur derived from the PET image
m_{ref} The ideal reference model
d_{ref} The ideal data-image determined from m_{ref}
mₛₛ A subset-model, which is a subset of a larger model-image
dₛₛ A subset-image, which is a subset of a larger data-image
dₛₛₒ A subset-image, which is one of a plurality of subset-images from the PET image. A subset-image is a data-image, which is a subset of the PET image.
mₛₛ* A model-image, which is a realizations of the prior ρ(m)
dₛₛ* A data-image, determined from mₛₛ* by dₛₛ*=g(mₛₛ*)
d_{ss,sim}* A sim-data-image, determined from mₛₛ* by d_{ss,sim}*=g(mₛₛ*)+n(mₛₛ*)
m_{f}* expected output from the machine learning system during training
mₒ output from the machine learning system
M* The sample of mₛₛ*
D* The data sample of dₛₛ*
Dₛᵢₘ* The simulated data sample of d_{ss,sim}*
M_{f}* The expected output sample

### REFERENCES

Tarantola, A., & Valette, B. Inverse problems=quest for information. Journal of geophysics, 50(1), 159-170 (1982).
Deutsch, C. V., & Journel, A. G. Geostatistical software library and user's guide. New York, 119(147) (1992).
Mariethoz, G., & Caers, J. Multiple-point geostatistics: stochastic modeling with training images. John Wiley & Sons (2014).
Bishop, Christopher M. Pattern, Recognition and machine learning. Springer (2006).
Kingma, Diederik P., and Jimmy Ba. “Adam: A method for stochastic optimization.” arXiv preprint arXiv: 1412.6980 (2014).

The above-listed references are hereby incorporated by reference in their entirety.

1. A computer-implemented method for image analysis and reconstruction for medical imaging of a subject, the method comprising:
obtaining a PET image and dividing the PET image into a plurality of subset-images dₛₛₒ, wherein each subset-image dₛₛₒ is a representation of one, or more, pixels,
providing a trained machine learning system,
applying the subset-images dₛₛₒ as input for the trained machine learning system,
obtaining a output mₒ for each subset-image dₛₛₒ from the trained machine learning system, and
determining and outputting a representation output based on the outputs mₒ.

2-15. (canceled)

16. The computer-implemented method for image analysis and reconstruction according to claim 1, wherein providing a trained machine learning system comprises:
obtaining a model-image mₛₛ* from a sample M*, wherein the model-image mₛₛ* is a realization from a prior ρ(m), the prior ρ(m) is a statistical model based on expert prior data, and each model-image mₛₛ* is a representation of an image of one, or more, pixels,
obtaining training sets, wherein each training set comprises a sim-data-image d_{ss,sim}* and an expected output m_{f}*, by determining the sim-data-image d_{ss,sim}* based on the model-image mₛₛ*, and selecting the expected output m_{f}* based on the model-image mₛₛ* for each sim-data-image d_{ss,sim}*, wherein each sim-data-image d_{ss,sim}* is a representation of one, or more, pixels,
applying the training sets as input for training the machine learning system, and obtaining a output mₒ for each sim-data-image d_{ss,sim}* from the machine learning system, and
training the machine learning system until the machine learning system converges based on comparing the outputs mₒ with the expected outputs m_{f}*.

17. The computer-implemented method for image analysis and reconstruction according to claim 1, wherein providing a trained machine learning system comprises:
selecting the trained machine learning system from a plurality of trained machine learning systems based on the type of the output mₒ to be obtained.

18. The computer-implemented method for image analysis and reconstruction according to claim 16, wherein the sim-data-image d_{ss,sim}* is determined from the model-image mₛₛ* by the function of the type d_{ss,sim}*=g(mₛₛ*)+n(mₛₛ*) and, wherein g is a smoothing function and n is a noise function.

19. The computer-implemented method for image analysis and reconstruction according to claim 16, wherein the selected expected output m_{f}* is the pixel intensity of the central pixel, or a group of central pixels in the model-image mₛₛ*.

20. The computer-implemented method for image analysis and reconstruction according to claim 16, wherein the selected expected output m_{f}* is the number of pixels connected to the central pixel in the model-image mₛₛ* with an intensity higher than a threshold intensity value or a probability of a disease is higher than a threshold probability value.

21. The computer-implemented method for image analysis and reconstruction according to claim 16, wherein the expected output m_{f}* is a category of the central pixel, or a group of central pixels, in the model-image mₛₛ* or the expected output m_{f}* is a probability for one or more categories.

22. The computer-implemented method for image analysis and reconstruction according to claim 16, wherein the expected output m_{f}* is a vector with two values, the mean and the covariance for a normal distribution.

23. The computer-implemented method for image analysis and reconstruction according to claim 1, wherein the output mₒ is a numerical value representative of a pixel intensity or a mean value and a covariance for a number of pixels, or a number of pixels, or the expected output mₒ is a category or a probability for one or more categories.

24. The computer-implemented method for image analysis and reconstruction according to claim 1, wherein the outputs mₒ are ordered into a representation output.

25. The computer-implemented method for image analysis and reconstruction according to claim 16, wherein the machine learning system comprises a regression type mapping, when the expected output m_{f}* represents a numerical value, or a classification type mapping, when the expected output m_{f}* represents a category.

26. The computer-implemented method for image analysis and reconstruction according to claim 1, wherein the machine learning system comprises a neural network.

27. A method for training a machine learning system for image analysis and reconstruction, the method comprising:
obtaining a model-image mₛₛ* from a sample M*, wherein the model-image mₛₛ* is a realization from a prior ρ(m), wherein the prior ρ(m) is a statistical model based on expert prior data and, wherein each model-image mₛₛ* is a representation of an image of one, or more, pixels,
obtaining training sets, wherein each training set comprises a sim-data-image d_{ss,sim}* and an expected output m_{f}*, by determining the sim-data-image d_{ss,sim}* based on the model-image mₛₛ*, and selecting the expected output m_{f}* based on mₛₛ* for each sim-data-image d_{ss,sim}*, wherein each sim-data-image d_{ss,sim}* is a representation of one, or more, pixels,
applying the training sets as input for training the machine learning system, and obtaining a output mₒ for each sim-data-image d_{ss,sim}* from the machine learning system, and
training the machine learning system until the machine learning system converges based on comparing the outputs mₒ with the expected outputs m_{f}*.

28. A medical imaging system comprising a scanner and a control system for scanning and recording a PET image, and a processor, wherein the processor is configured to:
obtain the PET image and dividing the PET image into a plurality of subset-images dₛₛₒ, wherein each subset-image dₛₛₒ is a representation of one, or more, pixels,
provide a trained machine learning system, wherein the subset-images dₛₛₒ are the input for the trained machine learning system,
obtain a output mₒ for each subset-image dₛₛₒ from the machine learning system, and
determine and output a representation output based on the output mₒ.

29. A computer program software comprising instructions which, when executed by a computer, cause the computer to carry out the method according to claim 1.
